(19) United States
(12) Patent Application Publication
(10) Pub. No.: US 2004/0073077 A1
(43) Pub. Date: Apr. 15, 2004

(54) Decomposition of nitrogen-based energetic material

(76) Inventor: Alfred Kornel, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/267,328

(22) Filed: Oct. 9, 2002

(51) Int. Cl. A62D 3/00; C01C 1/08

(52) U.S. Cl. 588/203; 423/358

(57) ABSTRACT

The present invention provides solutions and methods to decompose nitrogen-based energetic materials. The solution is an aqueous solution comprising a water soluble carbohydrate and having a pH greater than 7.0. The solution may optionally include a base. Pure or contaminated nitrogen-based energetic material is exposed to the solution at mild conditions and may be heated to enhance decomposition. The products and by products of the decomposition are water soluble and non-explosive. The solution provides a useful, convenient, and inexpensive method to decompose large quantities of otherwise dangerous energetic material.

### BACKGROUND OF THE INVENTION

I. Field of the Invention

The present invention relates to decomposition of nitrogen-based energetic material, and more particularly, to water soluble solutions which may be used to decompose such energetic material.

II. Description of the Prior Art

Dangerous and deadly materials, such as bombs, grenades, dynamite, land mines, plastic explosives, propellants, and other munitions or ordinance, have been used globally for battles, wars, and to generally cause destruction of land, property and people. Such materials contain energetic compounds, and in particular nitrogen-based energetic compounds, which release quantities of energy upon explosion. Literally millions of tons of these nitrogen-based energetic materials are either in storage or ‘in use’. There is significant interest in disposing significant volumes of these materials. For example, there are old, unexploded munitions lying around the countryside which present hazards to the general population who may happen upon them, an increasingly common event as populations spread. There are also efforts aimed at eliminating some of these energetics, such as land mines. And there is simply the need to dispose of some of the energetic material for political, social, or economic reasons.

Disposal of energetic materials has thus far presented significant drawbacks. For example, incineration has been proposed for disposal of munitions. However, incineration risks explosion, and is believed limited to handling very small munitions, such as bullets, and in very small quantities. More complex containment and incineration techniques have been developed, such as Plasma Arc incineration for disposal of TNT (2,4,6 trinitrotoluene). Plasma Arc incineration requires that the TNT first be dissolved in a solvent. However, TNT is not soluble in water, although it is slightly soluble in organic solvents, such as toluene. As a consequence, disposal of large amounts of TNT would require hundreds of millions of gallons of toluene, along with the risks presented by use of such materials.

One recent proposal is base hydrolysis in which the energetic material is exposed to water and high concentrations of sodium hydroxide a high temperatures. While base hydrolysis appears to provide an approach to decomposition of energetic material in an aqueous solution, there are several drawbacks. For example, base hydrolysis is not believed to be very effective at low concentrations of sodium hydroxide or at low temperatures such as at room temperature. Moreover, amines appear to be produced as a byproduct of base hydrolysis.

Other proposals for disposal of nitrogen-based energetic material include solvated electron treatment, alkaline hydrolysis, composting as disclosed in U.S. Pat. No. 6,051,420, the Silver II Process of AEA Technology Products and Systems, Scotland, degradative processes utilizing organisms and plants, such as bacteria and fungi, and enzymatic processes to decompose nitrogen-based energetic material. However, all of these alternative proposals have serious drawbacks. For example, solvated electron treatment involves liquid ammonia and reactive metals, such as sodium, calcium and potassium, in large quantities combined with the energetic material in pressurized and heated containment vessels. The liquid ammonia and metals must be transported to the disposal site in bulk, such as by train-car or tanker truck loads. Risks to the public can be presented during transportation such as in the case of a train derailment, or the like. Further, these reactant materials are themselves very dangerous and must be handled with extreme care. Moreover, the heating and pressurization of the containment vessel presents still further risks.

Degradation and decomposition methods relying upon organisms, plants and enzymes are extremely slow-acting and so are not necessarily well suited to disposal of significant quantities of energetic material. Common to most of the alternative proposals is the further drawback that they are not well suited to disposal of a wide variety of nitrogen-based energetic compounds or the various matrices in which they are found.

### SUMMARY OF THE INVENTION

The present invention provides solutions and methods for decomposing nitrogen-based energetic materials which overcome the above-mentioned drawbacks associated with prior disposal techniques. To this end, and in accordance with the principles of the present invention, an aqueous solution having a pH of greater than 7.0 and adapted to decompose nitrogen-based energetic materials is provided by combining water, a water soluble carbohydrate, and optionally a base. An amount of the nitrogen-based energetic material is exposed to the aqueous solution for decomposition thereof. For example, the energetic material and the aqueous solution may simply be combined, such as by pouring one onto or into the other, or by spraying the aqueous solution onto the energetic material, by way of examples. Alternatively, the aqueous solution may be formed in the presence of the energetic material.

The present invention permits decomposition of sizeable quantities of nitrogen-based energetic materials in a relatively short period of time, in a non-flammable or incinerating environment, and without the need to employ high temperatures, high pressures, extremely dangerous chemicals or dangerous levels of chemicals to the energetic material. The decomposition may occur at room temperature, although heat may be applied to enhance the rate and/or to complete the decomposition. Also, higher concentrations of the water soluble carbohydrate and/or base, if used, in the aqueous solution generally increase the rate of decomposition.

Advantageously, the water soluble carbohydrate is a saccharide, such as one or a combination of dextrose, glucose, sucrose, arabinose, lactose, mannose, maltose, fructose, galactose, amylose, allose, altose, talose, gulose, idose, ribose, erythrose, threose, lyxose, xylose, rhamnose, invert sugar, corn sugar, inositol, glycerol, and glycogen. Further advantageously, the water soluble carbohydrate is present in a concentration of about 0.1% to about 40% by weight per volume of the aqueous solution. If the carbohydrate in the aqueous solution does not provide a basic pH, a base may be used. Suitable bases include alkaline bases such as one or a combination of sodium hydroxide, potassium hydroxide, lithium hydroxide, calcium hydroxide, and calcium oxide. Further advantageously, the base is present in a concentration from about 0.1% to about 40% by weight per volume of the aqueous solution. Inclusion of the water soluble carbohydrate is believed to overcome the drawbacks associated with base hydrolysis.

In accordance with a further aspect of the present invention, ammonia gas is generated as a primary by-product. Ammonia gas may be captured and recycled by known techniques, thus avoiding the problems and risks associated with prior disposal techniques which generated nitrogen oxide and amine as a by-product.

By virtue of the foregoing, there are thus provided solutions and methods for decomposing nitrogen-based energetic material which overcomes some of the drawbacks associated with prior disposal techniques. These and other objects and advantages of the present invention shall be made apparent from the accompanying drawings and description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective diagram of a simple system for decomposing energetic materials for the purposes of explaining the principles of the present invention;

FIG. 2 is a cross-sectional view of the system of FIG. 1 with an included, optional, heat source;

FIG. 3 is a diagramatic view of another disposal system for use in decomposing energetic materials in accordance with the principles of the present invention; and

FIG. 4 is a diagramatic view of yet another disposal system for use in decomposing energetic materials in accordance with the principles of the present invention.

### DETAILED DESCRIPTION OF THE INVENTION

The present invention provides solutions and methods to decompose nitrogen-based energetic materials in a more timely and cost effective manner than techniques of the prior art. The term “nitrogen-based energetic material”, as used herein, is intended to refer to materials containing explosive nitrogen-based compounds. Dangerous and deadly explosive materials, such as bombs, grenades, plastic explosives, land mines, dynamite, munitions, propellants, explosive residue on ordinance or scrap, and their products and by-products of manufacture, for example, generally contain nitrogen-based compounds which are typically responsible for the explosive and energetic nature of the material. In addition, materials, such as soils, sludge, water, and the like, contaminated with fully and/or partially exploded or totally un-exploded bombs, land mines, dynamite and similar explosive materials may also be decomposed with the solutions and methods of the present invention. The present solution decomposes the explosive nitrogen-based compound(s) thereby reducing or completely eliminating the risks associated with the energetic material in question. Examples of nitrogen-based compounds which may be decomposed by the present invention include, without limitation, mono-nitrotoluene, dinitrotoluene, trinitrotoluene, mono-nitrobenzene, dinitrobenzene, trinitrobenzene, dinitrophenol, trinitrophenol, nitroglycerine, nitrocellulose, nitroaromatic, nitroaliphatic, nitrocyclicaliphatic, nitroguanidine, nitromethane, tetryl (N-methyl-N-2,4,6-tetranitrobenzeneamine), cyclonite, pentaerythritol tetranitrate, octogen, and combinations thereof. It should be understood that the general terms are representative of classes of compounds. For example, the term ‘nitroaromatic’ as used herein, refers to a class including all compounds having a nitro group on an aromatic ring. Whereas, specific terms, such as cyclonite, refers to a specific compound.

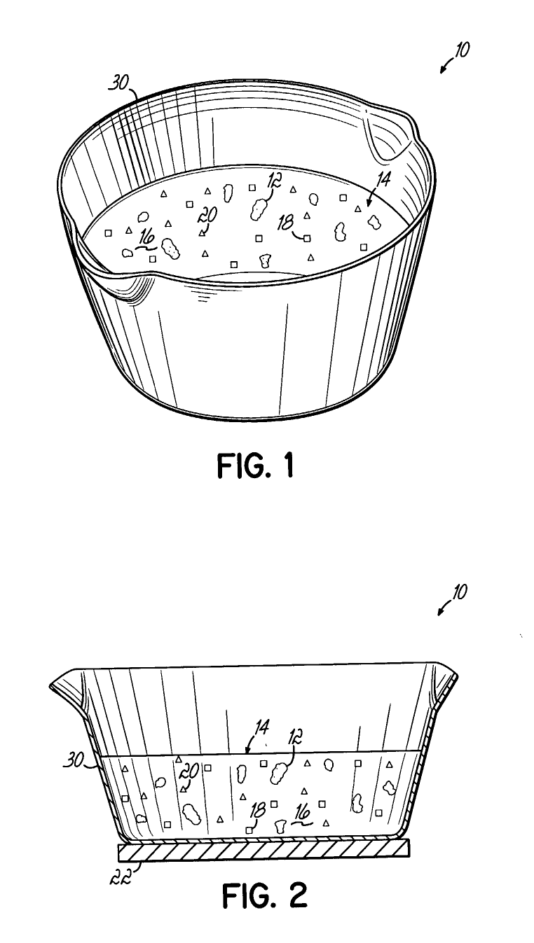

Referring to FIG. 1, and in accordance with the principles of the present invention, there is shown a simple system 10 for decomposing an amount of nitrogen-based energetic material 12. To this end, an aqueous solution 14 having a pH greater than 7.0 is prepared by mixing or combining water 16 with an amount of a water soluble carbohydrate 18. If necessary or desired, an amount of a base 20 may optionally be included. An amount of the energetic material 12 is exposed to the aqueous solution 14 for decomposition thereof such as, by way of example, placing both the energetic material 12 and aqueous solution 14 together into a vessel 30. It would be more beneficial if vessel 30 is made of a convenient material, such as glass, ceramic, metal, or plastic, for example, which is inert or non-reactive to the aqueous solution 14, the water soluble carbohydrate 18, and/or the base 20.

The term “water soluble carbohydrate”, as used herein, is intended to refer to carbohydrates that are both partially and completely soluble in water. For the purposes of illustration only, the water soluble carbohydrate 18 is shown as a discrete component, but as would be appreciated, it is dissolved in the water 16. It has been discovered that a water-soluble carbohydrate 18 when included in an aqueous solution having a pH greater than 7.0 is active in decomposing nitrogen-based energetic materials 12. To this end, it is believed that the hydroxyl groups of the water-soluble carbohydrate 18 react with nitrogen containing functional groups of compounds present in the energetic material 12. For example, to decompose an energetic material 12 having a nitro-group containing compound, it is believed that the hydroxyl groups of the carbohydrate 18, in a basic solution 14, will attack and displace both aliphatic and aromatic nitro-groups from the compound and release them as nitrites, nitrates, or other decomposed forms, into the solution 14 or into the air.

One or more carbohydrates 18 may be used to form the decomposing solution 14. Suitable carbohydrates 18 include saccharides such as mono-saccharides, di-saccharides, and poly-saccharides. For example, the carbohydrate 18 may be, without limitation, glucose, dextrose, sucrose, arabinose, lactose, mannose, maltose, fructose, glactose, amylose, allose, altose, talose, gulose, idose, ribose, erythrose, threose, lyxose, xylose, rhamnose, invert sugar, corn sugar, inositol, glycerol, glycogen, or a combination thereof. In one embodiment of the present invention, the water soluble carbohydrate 18 is sucrose. Suitable carbohydrates 18 are relatively inexpensive, are readily obtained from commercial sources, and are environmentally safe.

The decomposing solution 14 is basic in nature, i.e., it has a pH of greater than 7.0. A carbohydrate alone may be sufficient to provide the basic pH for solution 14. If not, then one of ordinary skill in the art may include a base 20 as desired, in accordance to the principles of the present invention, to adjust the pH of the solution 14. For the purposes of illustration only, the base 20 is shown as a discrete component in FIG. 1, but as would be appreciated, it is dissolved in the water 16. One or more suitable bases 20, such as an alkaline base for example, may be added to the decomposing solution 14 to maintain a basic pH. Examples of suitable alkaline bases include, but are not limited to, sodium hydroxide, potassium hydroxide, lithium hydroxide, calcium hydroxide, calcium oxide, and combinations thereof. Suitable alkaline bases are easily obtained commercially and are reasonably inexpensive.

The rate at which the energetic material 12 is decomposed is generally influenced by the concentration, in the solution 14, of the carbohydrate 18, and the base 20, if added. The concentration of the carbohydrate 18 in the solution 14 may be at least about 0.1% by weight per volume of the solution 14, and advantageously, at a higher concentration, such as up to about 40% by weight per volume of the solution 14. Higher carbohydrate 18 concentrations in the solution 14 generally result in a faster decomposition of the energetic material 12.

The alkalinity of solution 14 generally influences the rate of decomposition of the energetic material 12. For instance, decomposition rates typically increase as the alkalinity increases above 7.0 and typically decrease as the alkalinity of the solution 14 approaches 7.0. While the pH of solution 14 may range as high as 13.5-14, it is advantageous for the pH to be between 7.1 and 13. In addition to affecting the alkalinity of solution 14, it is believed that the base 20 may also participate in decomposing the energetic material 12. Therefore, the concentration of the base 20 in solution 14 generally affects the rate of decomposition. As with the carbohydrate, higher concentrations of base 20 typically decompose the energetic material 12 faster. The base 20 is present in the solution 14 in a concentration range of at least about 0.1% and may be in the range of about 1% to about 40% by weight per volume of the solution 14. Higher base 20 concentrations result in caustic solutions 14 and dangerous decomposition conditions.

While operation at high temperature and with high concentrations of base 20 is within the scope of the present invention, the presence of the carbohydrate 18 is believed to improve over the base hydrolysis method and to reduce the need to rely on such high concentrations and temperatures. More particularly, it is believed that the base 20 activates the carbohydrate 18 to render it a stronger decomposing component than the base 20 alone. Thus, a solution 14 having equal or greater amount of carbohydrate 18 relative to base 20 generally decomposes energetic materials 12 as completely as a solution 14 having less carbohydrate 18 relative to base 20, but does so with a milder solution 14 and under milder conditions, i.e., at a lower pH and at a lower temperature. To this end, the carbohydrate 18, an inexpensive commodity in most countries in the world, in the presence of a base 20 allows decomposition to occur in less time and at a lower temperature and pH thereby providing distinct advantages over the base hydrolysis method.

Other factors influencing the rate of decomposition of the energetic material 12 include, for example, the general class of nitrogen-containing compounds in the energetic material 12 and the particular carbohydrate 18 and base 20 utilized in the solution 14. For example, different carbohydrates 18 and bases 20 will typically influence the decomposition of different nitrogen-based energetic materials 12 differently depending upon the solubility of the energetic material 12, the carbohydrate 18 and/or the base 20 in the solution 14 and the degree of participation in the decomposition by the carbohydrate 18 and/or base 20 used in solution 14. In addition to the above factors, decomposition of energetic material 12 may be further enhanced with the addition of heat to the solution 14 decomposing the energetic material 12 (FIG. 2).

The aqueous solution 14 may be formed by various methods. For example, water 16 may be added to a water-soluble carbohydrate 18 or vice versa to form the solution 14, preferable in a vessel 30. The base 20 may be added at any point in forming solution 14. The amounts of water 16, the water soluble carbohydrate 18 and the base 20, may vary as desired. Advantageously, a nitrogen-based energetic material 12 is decomposed with a solution 14 including a water soluble carbohydrate 18 selected from the group consisting of sucrose, glucose, fructose, dextrose, lactose, mannose, invert sugar, corn sugar and combinations thereof, and present in the solution 14 in a concentration range of about 0.1% to about 40.0% by weight per volume of the solution 14, and an alkaline base 20 in a concentration range of from about 0.1% to about 40.0% by weight per volume of the solution 14. The above embodiment of a solution 14 is merely an example and the present invention is not so limited.

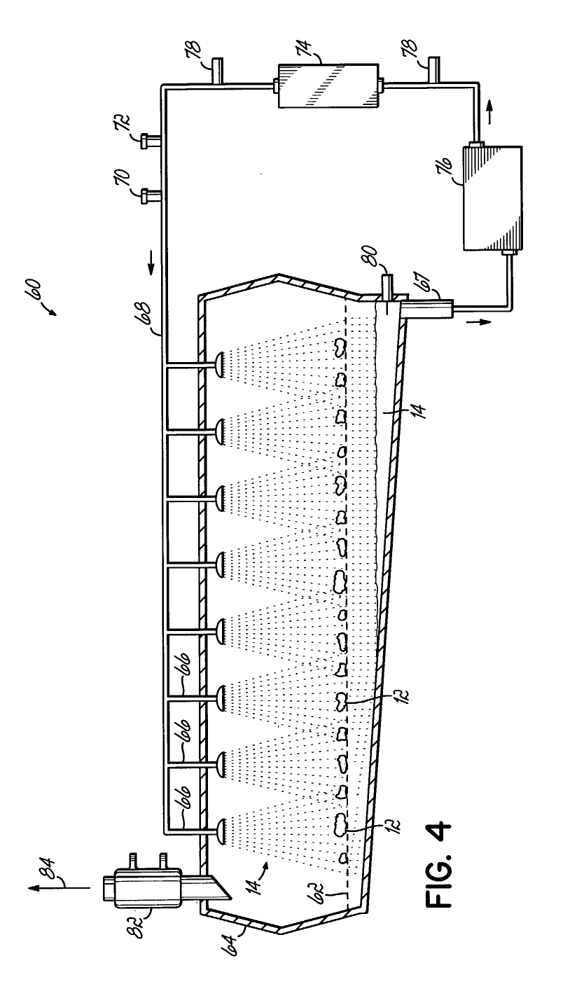

Referring to FIG. 2, the nitrogen-based energetic material 12 is decomposed by exposing the energetic material 12 to the aqueous solution 14. Exposure of energetic material 12 may be accomplished by a variety of techniques. For example, an amount of an energetic material 12 may be added to an aqueous solution 14 previously placed in a vessel 30. Alternatively, energetic material 12 may be placed in vessel 30 with solution 14 subsequently added to vessel 30, or both the energetic material 12 and the solution 14 may be added simultaneously to vessel 30, to begin decomposition of the energetic material 12. Further alternatively, solution 14 may be sprayed onto the energetic material 12 (FIG. 4). Still further, the energetic material 12 may be first placed into plain water 16 which may be used to form the aqueous solution 14 having a pH of greater than 7.0 by subsequent addition of a water soluble carbohydrate 18, and optionally a base 20. In this manner, the solution 14 is formed simultaneously with exposure of the energetic material 12 thereto. In short, while the method and order of exposure is not critical, exposure of one of the energetic material 12 and the aqueous solution 14 to the other is necessary for decomposition of energetic material 12.

It is believed that the decomposition reaction occurs on the surface of the energetic material 12 to form water-soluble products and by-products. To this end, dissolution of the energetic material 12 in the solution 14 is not necessary for decomposition to take place. Referring again to FIG. 2, the nitrogen-based energetic material 12 may be insoluble and remain suspended in the aqueous solution 14. Decomposition generally begins upon exposure, typically contact, of the energetic material 12 to the solution 14. However, complete decomposition may further require heating. To this end, the solution 14 may be heated with a heat source 22. The heat source 22 may be any conventional heating apparatus depending upon the particular vessel 30. Certain energetic materials 12 will decompose at room temperature depending upon the various factors influencing the rate of decomposition, as discussed above, while other energetic materials 12 may decompose only at temperatures higher than room temperature. In one embodiment, the solution 14, containing the energetic material 12, is heated to a temperature in the range of from about 40° C. to about 100° C. Beyond 100° C., the water in the solution 14 will generally vaporize to steam thereby concentrating the components of the solution 14 and possibly rendering the decomposition process more dangerous.

Decomposition of the energetic material 12 is typically evident by a change in the color of the solution 14 as the decomposition progresses. For example, the products from a decomposition reaction with PETN result in a solution 14 that is typically pale yellow in color. Also, RDX and HMX decomposition products give a solution 14 that typically turns from yellow to red in color as the decomposition progresses towards completion. The decomposition of TNT, however, generally results in a darker color or a black solution 14 once the TNT is completely decomposed. Advantageously, the products and by-products generated from the decomposition of the energetic materials 12 are generally water soluble, non-explosive and may be safely disposed.

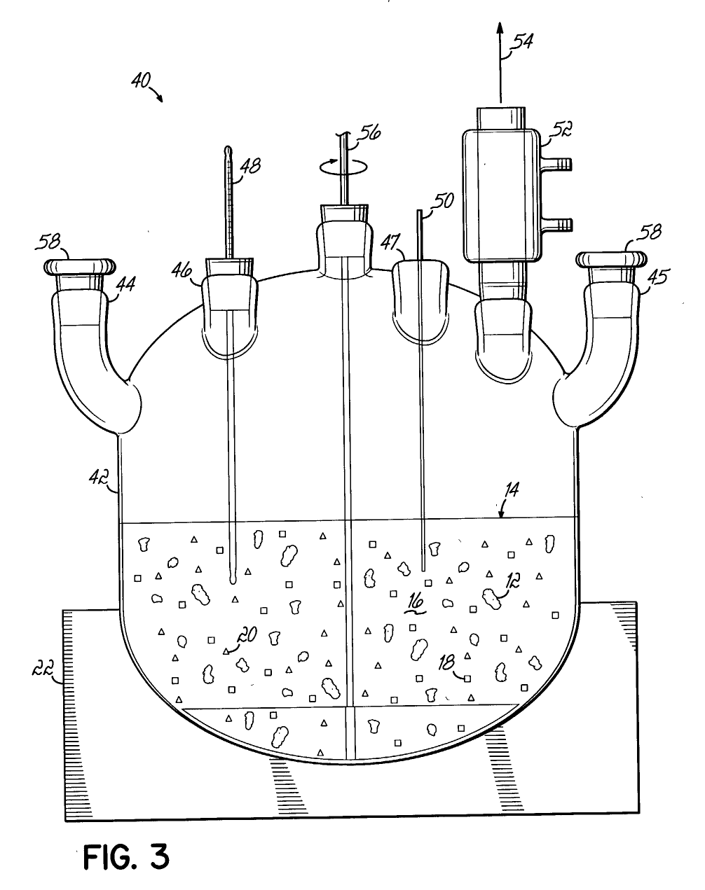

Referring to FIG. 3, an amount of a nitrogen-based energetic material 12, may be decomposed in a vessel, such as a round bottom flask, in a disposal system 40. System 40 comprises a heat source 22 and a glass round bottom flask 42. The energetic material 12 is exposed to an aqueous solution 14 containing a water soluble carbohydrate 18 and having a pH greater than 7.0 in flask 42. Flask 42 advantageously has one or more inlet openings or ports, such as inlet ports 44-47 respectively. Inlet ports 44 and 45 may be used to add to solution 14 additional water soluble carbohydrate 18 and/or base 20 as necessary to maintain desired concentrations and pH in solution 14. Inlet ports 44 and 45, as with other ports in the flask 42, are normally closed with stoppers 58 when not in use. Inlet ports 46 and 47 may serve to insert equipment to monitor the decomposition reaction. For example, either of ports 46 or 47 may be used to equip flask 42 with a temperature probe, such as a thermometer 48 as shown, to monitor the temperature of the solution 14. Similarly, flask 42 may be equipped with a pH probe 50 to monitor the pH of solution 14 for maintaining a desired basic pH, or pH range, for the decomposition process. Further, the flask 42 may be equipped with a reflux condenser 52 through which an effervescence or evolution of gas 54, such as ammonia gas, may be removed from the flask 42 and recovered via an appropriate gas treatment system or a gas collection apparatus (not shown). As shown, a stirrer 56, such as a mechanical stirrer, may be fitted and adapted to stir the aqueous suspension of the energetic material 12. The mechanical stirrer 56 may be air driven or mechanically driven to prevent failure. Further, the heat source 22, such as a heating mantle or an oil bath, is adapted to heat solution 14 in flask 42. The disposal system 40 is particularly useful in decomposing loose energetic materials found in soils, on the surface of clothing, and other materials as the result of an explosion or other compressed energetic material 12.

During decomposition of certain nitrogen-based energetic materials 12 with the solution 14 described above, it was discovered that gas 54, and in particular, ammonia gas, is produced as a product of the decomposition reaction. With reference to FIG. 3, a reflux condenser 52 may advantageously be used to remove gas 54 for recovery by conventional techniques to avail gas 54 for further use. To this end, the inventive decomposition solutions and methods provide a convenient and useful alternative to the release of nitric oxide and amine, by-products of the prior art techniques.

Referring to FIG. 4, is shown another exemplary disposal system 60 used to expose and decompose an amount of a energetic material 12 with an aqueous solution 14. System 60 is particularly adapted to recycle solution 14. As shown, the energetic materials 12 are generally placed on a screen 62 in a vessel or, as shown, in a metal tank 64. Tank 64 has two portions, a lower portion and an upper portion. Tank 64 is generally kept closed during decomposition of energetic material 12. An aqueous solution 14 containing a water soluble carbohydrate 18 (dissolved) and having a pH greater than 7.0 may be added to the tank 64 and onto the energetic materials 12 on the screen 62 by spray through the spray nozzles 66. Solution 14 may be pre-mixed or blended in spray lines 68 by adding, to the water 16 in the lines 68, the carbohydrate 18, and optionally a base 20, individually through ports 70 and 72. Ports 70 and 72 are also useful for the addition of extra water soluble carbohydrate 18 and/or base 20 as the concentrations of carbohydrate 18 and/or base 20, if added, and/or pH of the solution 14 reduces due to consumption during the decomposition reaction. For the purposes of illustration only, solution 14 is shown to be below the level of the screen 62. However, amounts of solution 14 may be provided so as to actually suspend or completely surround energetic materials 12 for decomposition thereof.

For purposes of efficiency, solution 14 may be recycled. More specifically, tank 64 has an exit drain 67 through which solution 14 flows to a pump 76, to recycle solution 14 back in to the spray lines 68 for subsequent spraying onto the energetic material 12. The lower portion of tank 64 may optionally be coupled to a heat exchanger 74 sufficient to heat the recycled solution 14 prior to being re-sprayed onto the energetic material 12. Alternatively, tank 64 may be provided with a heat source (not shown) to heat solution 14 containing the energetic material 12. As with the disposal system illustrated in FIG. 3, system 60 may include a temperature probe 78 and a pH probe 80 to monitor the temperature and pH of solution 14 respectively, for maintaining the desired temperature and pH of solution 14. A reflux condenser 82 may be fitted to the upper portion of tank 64 to allow for removal of vapors and gases 84 from the decomposition reaction. The disposal system 60 is particularly useful for larger quantities of compressed or pressed energetic material such as shell castings, land mines, dynamite sticks, bombs, grenades, plastic explosives, and the like.

The benefits and advantages of the solutions and methods for decomposing nitrogen-based energetic materials in accordance with the principles of the present invention will be further appreciated in light of the following examples.

### EXAMPLE 1

Decomposition of 2,4-dinitrotoluene (DNT):

To a 150 cc glass beaker was added 50 cc of an aqueous solution containing sodium hydroxide and sucrose in water, each at a concentration of 2% weight/volume of solution. The beaker also contained a magnetic stirrer and was placed on a magnetic stirring hot plate. Commercial DNT (100 mg) was added to the aqueous, sodium hydroxide-sucrose solution at 40° C. Within a few minutes the clear solution changed in color to pale yellow. The solution was continuously heated to a temperature of about 90-95° C. and the solution became a darker brown-black color. The solution was maintained at 90-95° C. for 30 minutes and allowed to cool. Upon cooling, the solution was worked-up in the following manner: the pH of the solution was adjusted to about 2 with sulfuric acid and the solution was washed more than once with toluene to extract residual organic materials, i.e., the products, by products and any non-decomposed DNT. The toluene extracts were combined and concentrated to dryness under vacuum. A GC-MS analysis of the residue revealed no analytical traces of DNT.

### EXAMPLE 2

Decomposition of 2,4,6 trinitrotoluene (TNT):

A 250 ml glass three neck round bottom flask was equipped with a reflux condenser, a temperature probe, and a pear-shaped teflon coated magnetic stir bar, and the flask was placed in a heating mantel on a magnetic stir plate. To the flask was added 100 ml of water, 2 grams of sodium hydroxide and 2 grams of sucrose. The aqueous solution was heated until the sodium hydroxide and the sucrose dissolved. The solution was then cooled to about 23° C. or room temperature. One gram of TNT was added to the solution at 23° C., and the solution was gently stirred. Upon addition of the TNT, the clear color of the solution became orange-yellow in color. The solution was heated to a temperature of 98° C. over a twenty minute period. During this 20 minute heating period the solution became a dark brown-black color leaving no visible traces of unreacted or non-decomposed TNT on the surface of the solution. The solution was maintained at 98° C. for 10 minutes. After the solution was allowed to cool, the work-up procedure from Example 1 was followed. Upon analytical GC-MS analysis of the extracted residue, no residual amount of TNT was detected.

### EXAMPLE 3

Decomposition of Cyclonite (RDX):

In a 250 ml glass round bottom flask equipped identically as that in Example 2, was placed 100 ml of water, 2 grams of sucrose and 2 grams of sodium hydroxide. The hydroxide and the sucrose were dissolved in the water by heating the aqueous solution to a temperature of about 32° to 34° C. Upon cooling the solution to RT, 2 grams of RDX crystals were added and the flask was heated to 98° C. with stirring. Visible inspection revealed evolution of ammonia as the decomposition commenced at about 40° C. The solution became a clear yellow-amber color within five minutes after reaching 98° C. The solution was cooled to room temperature and worked up using the same procedure as in Example 1. Upon analytical GC-MS analysis of the extracted residue, no residual amount of RDX was detected.

Thus, the present invention provides solutions and methods of decomposing nitrogen based energetic materials without the drawbacks associated with techniques disclosed in the prior art. In doing so, the present solutions and methods allow decomposition of dangerous nitrogen-based energetic materials in the presence of a carbohydrate, and optionally a base, in water. The products and by-products of decomposition are, for the most part, water soluble and non-explosive thereby eliminating the hazards and concerns of disposing the decomposed waste from prior art methods. In addition, the water soluble carbohydrates and the bases are cheap and readily available from commercial sources allowing for the aqueous solution to be inexpensively prepared, conveniently used, and effective in decomposing large quantities of nitrogen-based energetic materials in less time than the techniques of the prior art. Further, one advantage of the present method includes the evolution and collection of usable ammonia gas as a product from the decomposition of nitro-group containing energetic materials. The solutions and methods thus provide advantages from a safety, health, and environmental standpoint with regard to people, plants, and animals encroaching into regions having been exposed to energetic materials.

While the present invention has been illustrated by the description of embodiments thereof, and while the embodiments have been described in considerable detail, it is not intended to restrict or in any way limit the scope of the appended claims to such detail. Additional advantages and modifications will be readily appear to those skilled in the art. For example, while the vessels and disposal systems described and illustrated are quite small and used to decompose small quantities of energetic materials, the invention is not so limited and larger disposal systems of suitable design and equipment may be used to decompose large quantities and varieties of energetic materials as necessary. The invention in its broader aspects is therefore not limited to the specific details, representative apparatus and method, and illustrated examples shown and described. Accordingly, departures may be made from such details without departing from the scope or spirit of Applicant's general inventive concept.

What is claimed is:

1. A method of decomposing nitrogen-based energetic materials comprising:
combining an alkaline base, a water soluble carbohydrate and water to form an aqueous solution having a pH greater than 7.0; and
exposing an amount of said nitrogen-based energetic material to the aqueous solution.

2. The method of claim 1 wherein the alkaline base is selected from the group consisting of sodium hydroxide, potassium hydroxide, lithium hydroxide, calcium hydroxide, calcium oxide, and combinations thereof.

3. The method of claim 2 wherein the alkaline base is present in a range of from about 0.1% to about 40% by weight per volume of the aqueous solution.

4. The method of claim 1 wherein the alkaline base is present in a range of from about 0.1% to about 40% by weight per volume of the aqueous solution.

5. The method of claim 1 wherein the water soluble carbohydrate is selected from the group consisting of dextrose, glucose, sucrose, arabinose, lactose, mannose, maltose, fructose, galactose, amylose, allose, altose, talose, gulose, idose, ribose, erythrose, threose, lyxose, xylose, rhamnose, invert sugar, corn sugar, inositol, glycerol, glycogen, and combinations thereof.

6. The method of claim 5 wherein the water soluble carbohydrate is present in a range of from about 0.1% to about 40% by weight per volume of the aqueous solution.

7. The method of claim 1 wherein the water soluble carbohydrate is present in a range of from about 0.1% to about 40% by weight per volume of the aqueous solution.

8. The method of claim 1 wherein the water soluble carbohydrate is sucrose.

9. The method of claim 8 wherein the water soluble carbohydrate is present in a range of from about 0.1% to about 40% by weight per volume of the aqueous solution.

10. The method of claim 8 wherein the aqueous solution has a pH in the range of about 7.1 to about 13.

11. The method of claim 1 wherein the aqueous solution has a pH in the range of about 7.1 to about 13.

12. A method of decomposing nitrogen-based energetic material comprising:
exposing an amount of a nitrogen-based energetic material to an aqueous solution having a pH greater than 7.0 and a water soluble carbohydrate included therein.

13. The method of claim 12 further comprising providing the aqueous solution.

14. The method of claim 12 further comprising heating the aqueous solution.

15. The method of claim 12 further comprising heating the aqueous solution to a temperature in the range of from about 40° C. to about 100° C.

16. The method of claim 12 wherein the water soluble carbohydrate is a saccharide.

17. The method of claim 16 wherein the saccharide is selected from the group consisting of dextrose, glucose, sucrose, arabinose, lactose, mannose, maltose, fructose, galactose, amylose, allose, altose, talose, gulose, idose, ribose, erythrose, threose, lyxose, xylose, rhamnose, invert sugar, corn sugar, inositol, glycerol, glycogen, and combinations thereof.

18. The method of claim 12 wherein the nitrogen-based energetic material is selected from the group consisting of mono-nitrotoluene, dinitrotoluene, trinitrotoluene, mono-nitrobenzene, dinitrobenzene, trinitrobenzene, dinitrophenol, trinitrophenol, nitroglycerine, nitrocellulose, nitroaromatic, nitroaliphatic, nitrocyclicaliphatic, nitroguanidine, nitromethane, tetryl (N-methyl-N-2,4,6-tetranitrobenzeneamine), Cyclonite, Pentaerythritol tetranitrate, Octogen, and combinations thereof.

19. A solution for decomposing nitrogen-based energetic materials comprising:
an aqueous solution having a pH greater than 7.0; and
a water soluble carbohydrate in the aqueous solution.

20. The solution of claim 19 further comprising an alkaline base in the aqueous solution.

21. The solution of claim 20 wherein the alkaline base is selected from the group consisting of sodium hydroxide, potassium hydroxide, lithium hydroxide, calcium hydroxide, calcium oxide, and combinations thereof.

22. The solution of claim 19 wherein the water soluble carbohydrate is a saccharide.

23. The solution of claim 22 wherein the saccharide is selected from the group consisting of dextrose, glucose, sucrose, arabinose, lactose, mannose, maltose, fructose, galactose, amylose, allose, altose, talose, gulose, idose, ribose, erythrose, threose, lyxose, xylose, rhamnose, invert sugar, corn sugar, inositol, glycerol, glycogen, and combinations thereof.

24. The solution of claim 19 wherein the water soluble carbohydrate is sucrose.

25. The solution of claim 19 wherein the water soluble carbohydrate is present in the solution in at least about 0.1% by weight per volume of the aqueous solution.

26. The solution of claim 20 wherein the alkaline base is present in at least about 0.1% by weight per volume of the aqueous solution.

27. The solution of claim 19 wherein the nitrogen-based energetic material is selected from the group consisting of mono-nitrotoluene, dinitrotoluene, trinitrotoluene, mono-nitrobenzene, dinitrobenzene, trinitrobenzene, dinitrophenol, trinitrophenol, nitroglycerine, nitrocellulose, nitroaromatic, nitroaliphatic, nitromethane, nitroguanidine, nitrocyclicaliphatic, tetryl (N-methyl-N-2,4,6-tetranitrobenzeneamine), Cyclonite, Pentaerythritol tetranitrate, Octogen, and combinations thereof.

28. A solution for decomposing nitrogen-based energetic materials comprising:
an aqueous solution having an alkaline base in a range of from about 0.1% to about 40% by weight per volume of the aqueous solution; and
a water soluble carbohydrate selected from the group consisting of sucrose, glucose, fructose, dextrose, lactose, mannose, invert sugar, corn sugar, and combinations thereof and present in the aqueous solution in a range of from about 0.1% to about 40% by weight per volume of the aqueous solution,
wherein the solution has a pH of greater than 7.0 and used to decompose a nitrogen-based energetic material.

29. The solution of claim 28 wherein alkaline base is selected from the group consisting of sodium hydroxide, potassium hydroxide, lithium hydroxide, calcium hydroxide, and combinations thereof.

30. The solution of claim 28 wherein water soluble carbohydrate is sucrose.

31. The solution of claim 28 wherein the nitrogen-based energetic material is selected from the group consisting of mono-nitrotoluene, dinitrotoluene, trinitrotoluene, mono-nitrobenzene, dinitrobenzene, trinitrobenzene, dinitrophenol, trinitrophenol, nitroglycerine, nitrocellulose, nitroaromatic, nitroaliphatic, nitromethane, nitroguanidine, nitrocyclicaliphatic, tetryl (N-methyl-N-2,4,6-tetranitrobenzeneamine), Cyclonite, Pentaerythritol tetranitrate, Octogen, and combinations thereof.

32. A method of generating ammonia gas comprising:
exposing an amount of nitrogen-based energetic material to an aqueous solution having a pH greater than 7.0 and a water soluble carbohydrate in the aqueous solution for a time sufficient to produce ammonia gas as a by-product thereof.
